(19) United States
(12) Patent Application Publication
(10) Pub. No.: US 2011/0179121 A1
(43) Pub. Date: Jul. 21, 2011

(54) Broadcast Message Management

(75) Inventors: Yuk Chan, Poughkeepsie, NY (US); Dwifuzi Coe, Poughkeepsie, NY (US); Gilbert Lee, Poughkeepsie, NY (US); Michael Wang, Poughkeepsie, NY (US)

(73) Assignee: INTERNATIONAL BUSINESS MACHINES CORPORATION, Armonk, NY (US)

(21) Appl. No.: 12/690,439

(22) Filed: Jan. 20, 2010

(51) Int. Cl. G06F 15/16

(52) U.S. Cl. 709/206

(57) ABSTRACT

A method for broadcast message management includes receiving, at a registration server, a registration comprising a first plurality of communication channels by a registration server, the first plurality of communication channels comprising a first communication channel and a second communication channel, the first communication channel being associated with a first service provider, the second communication channel being associated with a second service provider; and providing the registration by the registration server to the first service provider, such that a status notification for a broadcast message, the broadcast message being received by a second plurality of communication channels comprising the first communication channel and the second communication channel, is sent to the second service provider from the first service provider.

### BACKGROUND

This disclosure relates generally to the field of broadcast message management.

A user may receive communications via multiple communication channels, or user accounts, such as one or more email accounts or phone numbers. When a contact of the user sends a message to the user, the contact may not know which of the user's communication channels may be the best communication channel to get the message to the user, so the contact may broadcast the message to multiple communication channels in order to ensure receipt by the user. The user may retrieve the message from any of the multiple communication channels. When the user receives the message in one communication channel, the other copies of the broadcast message residing in other communication channels are no longer important to the user. However, when the user checks for messages in other communication channels, the copies of the broadcast message may appear, requiring the user to manually manage the copies of the broadcast message.

### SUMMARY

An exemplary embodiment of a method for broadcast message management includes receiving, at a registration server, a registration comprising a first plurality of communication channels, the first plurality of communication channels comprising a first communication channel and a second communication channel, the first communication channel being associated with a first service provider, the second communication channel being associated with a second service provider; and providing the registration by the registration server to the first service provider, such that a status notification for a broadcast message, the broadcast message being received by a second plurality of communication channels comprising the first communication channel and the second communication channel, is sent to the second service provider from the first service provider.

An exemplary embodiment of a system for broadcast message management includes a first communication channel associated with a first service provider; a second communication channel associated with a second service provider; and a registration server configured to receive a registration comprising a first plurality of communication channels by a registration server, the first plurality of communication channels comprising the first communication channel and the second communication channel, the registration server further configured to provide the registration to the first service provider, such that a status notification for a broadcast message, the broadcast message being received by a second plurality of communication channels comprising the first communication channel and the second communication channel, is sent to the second service provider from the first service provider.

An exemplary embodiment of a computer program product includes a computer readable storage medium containing computer code that, when executed by a computer, implements a method for broadcast message management, wherein the method includes receiving, at a registration server, a registration comprising a first plurality of communication channels, the first plurality of communication channels comprising a first communication channel and a second communication channel, the first communication channel being associated with a first service provider, the second communication channel being associated with a second service provider; and providing the registration by the registration server to the first service provider, such that a status notification for a broadcast message, the broadcast message being received by a second plurality of communication channels comprising the first communication channel and the second communication channel, is sent to the second service provider from the first service provider.

Additional features are realized through the techniques of the present exemplary embodiment. Other embodiments are described in detail herein and are considered a part of what is claimed. For a better understanding of the features of the exemplary embodiment, refer to the description and to the drawings.

### BRIEF DESCRIPTION OF THE SEVERAL VIEWS OF THE DRAWINGS

Referring now to the drawings wherein like elements are numbered alike in the several FIGURES:

FIG. 1 illustrates an embodiment of a system for broadcast message management.

FIG. 2 illustrates an embodiment of a method for broadcast message management.

FIG. 3 illustrates an embodiment of a computer that may be used in conjunction with systems and methods for broadcast message management.

### DETAILED DESCRIPTION

Embodiments of systems and methods for broadcast message management are provided, with exemplary embodiments being discussed below in detail. When a contact of a user sends a broadcast message to the user through multiple communication channels, the user may access the message from one of the multiple communication channels. A status notification reflecting the receipt of the message may be sent to the other communication channels belonging to the user. Hence, the user is not required to manually manage the duplicate copies of the broadcast message in the other communication channels.

For example, a sender may wish to send an urgent message to a user, but the sender may not know which communication channel the user will check first. The sender may broadcast a plurality of identical messages to all the linked communication accounts belonging to the user; for example, the user may have linked their email and short message service (SMS) accounts. The user may receive a notification that a new SMS from the sender is available on the user's cellular phone. The user may read the SMS on the cellular phone, and reply the sender. The cellular phone then sends a notification to the user's cellular provider indicating this specific SMS is read and replied. In response, the cellular provider may send a read/reply status notification identifying the message to the user's linked email account, so that when the receiver later checks the email account, the broadcast message is flagged as read and replied.

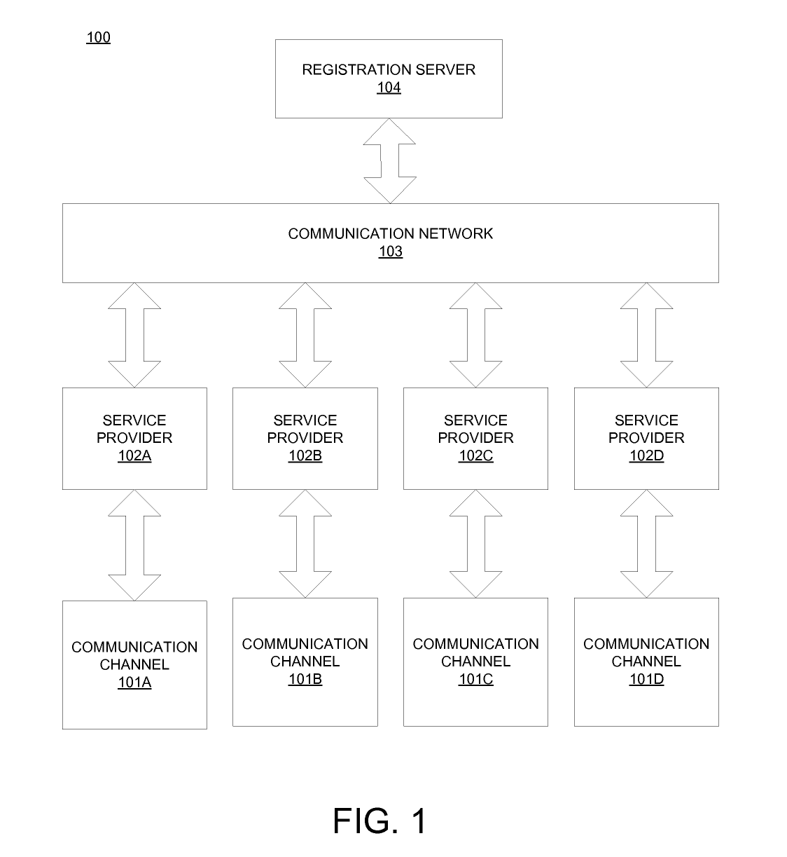

FIG. 1 illustrates an embodiment of a system 100 for automatic broadcast message management. Communication channels 101A-D are in communication with registration server 104 via respective service providers 102A-D and communication network 103. Service providers 102A-D communicate with each other and with registration server 104 via communication network 103. Communication channels 101A-D may comprise any communication channel, including but are limited to include email addresses, short message service (SMS), voicemail, or chat. Service providers 102A-D may comprise any communication service providers, including but not limited to internet service providers (ISPs), email service providers such as Google®, Yahoo®, or Hotmail®, or cellular providers. Communication network 103 may comprise any number of appropriate communication networks, including but not limited to local area networks (LANs), wider area networks (WANs), or the Internet. Communication channels 101A-D, service providers 102A-D, and communication network 103 are shown for illustrative purposes only; a user may have any appropriate number of communication channels having respective service providers, any service provider may communicate with any number of users and accounts, and communication network 103 may be connected to any number of service providers. A user may communicate with communication channels 101A-D in any appropriate manner, including but not limited to a cellular phone, a personal digital assistant (PDA), a laptop or desktop computer, or a beeper.

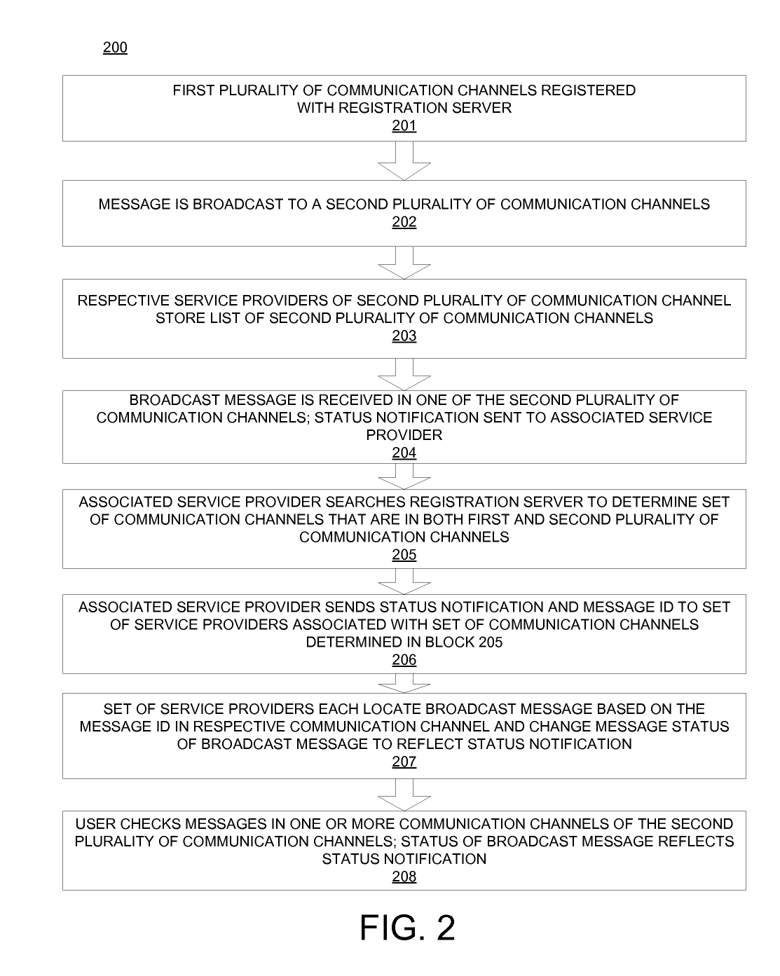

FIG. 2 illustrates an embodiment of a method for automatic broadcast message management. FIG. 2 is discussed with reference to FIG. 1. In block 201, a first plurality of communication channels that are to be grouped together are registered with registration server 104. The first plurality of communication channels registered with registration server 104 may be referred to as a preset group. The first plurality of communication channels may belong to a single user in some embodiments; in other embodiments the first plurality of communication channels may belong to multiple users. Authentication information for each of the first plurality of communication channels such as username and password, may also be provided to registration server 104. In block 202, a contact of the user (or message sender) broadcasts a message to a second plurality of communication channels, via their respective service providers and communication network 103. The second plurality of communication channels to which the broadcast message is sent may include all of, or any subset of, the first plurality communication channels registered with the registration server 104 in block 201. The set of communication channels to which the broadcast message is sent may further include additional communication channels not registered with the registration server 104. The broadcast message may comprise a unique message identifier (ID) associated with the message, such as a message size and/or timestamp. In block 203, upon receiving the message, each of the service providers associated with the second plurality of communication channels retains a list of the second plurality of communication channels that received the broadcast message.

In block 204, the user receives the broadcast message from one of the second plurality of communication channels. For example, the user may receive the broadcast message from communication channel 101A. Communication channel 101A sends a status notification for the broadcast message comprising the broadcast message's unique message ID to the communication channel's associated service provider 102A. The status notification may comprise any manner of indicating that the user has received the broadcast message, including but not limited an indication that the broadcast message has been received, read, replied, forwarded, and/or deleted. In block 205, service provider 102A receives the status notification from communication channel 101A, and searches in registration server 104 to determine a set of communication channels that are in both the first and second plurality of communication channels. In this example, communication channels 101B-D may be in both groups. Authentication information for each of communication channels 101B-D may then be determined based on information from registration server 104.

In block 206, service provider 102A sends, via communication network 103, the status notification for the broadcast message comprising the unique message ID to service providers 102B-D, which are associated with the set of communication channels determined in block 205. The status notification may also comprise respective authentication information for each of communication channels 101B-D. In block 207, upon receiving the status notification and unique message ID, each of service providers 102B-D may validate their respective authentication information, and perform a look-up of the broadcast message in the service providers' respective communication channel 101B-D using the unique message ID. The status of the broadcast message is then changed to reflect the status notification in each of communication channels 101B-D. For example, if the user has taken an action regarding the broadcast message in communication channel 101A, such as reading, replying, forwarding or deleting the broadcast message, this status change is reflected in communication channels 101B-D. In block 208, the user checks for messages in one or communication channels 101B-D. The status of the broadcast message reflects the status notification received from communication channel 101A (i.e., read, forwarded, replied, deleted, etc.) in each of communication channels 101B-D.

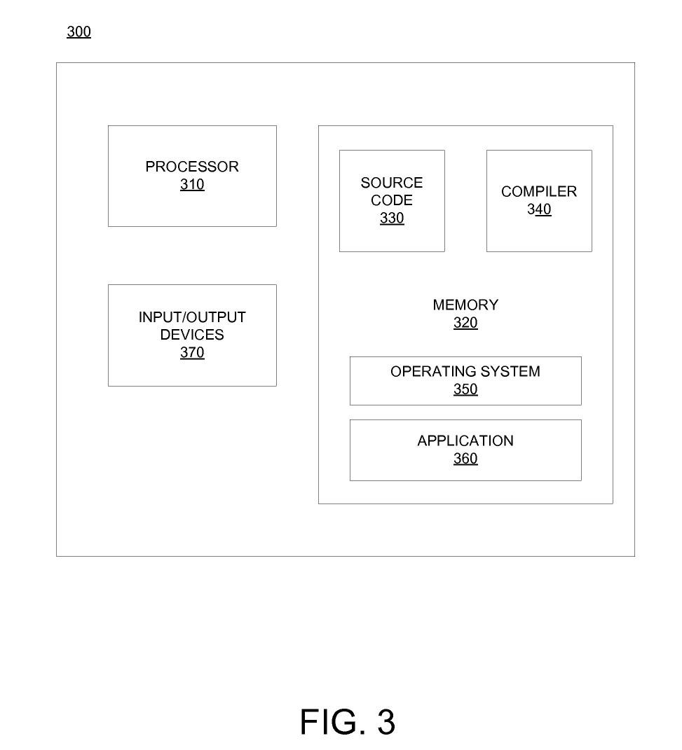

FIG. 3 illustrates an example of a computer 300 which may be utilized by exemplary embodiments of a method for broadcast message management as embodied in software. Various operations discussed above may utilize the capabilities of the computer 300. One or more of the capabilities of the computer 300 may be incorporated in any element, module, application, and/or component discussed herein.

The computer 300 includes, but is not limited to, PCs, workstations, laptops, PDAs, palm devices, servers, storages, and the like. Generally, in terms of hardware architecture, the computer 300 may include one or more processors 310, memory 320, and one or more input and/or output (I/O) devices 370 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 310 is a hardware device for executing software that can be stored in the memory 320. The processor 310 can be virtually any custom made or commercially available processor, a central processing unit (CPU), a digital signal processor (DSP), or an auxiliary processor among several processors associated with the computer 300, and the processor 310 may be a semiconductor based microprocessor (in the form of a microchip) or a macroprocessor.

The memory 320 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 320 may incorporate electronic, magnetic, optical, and/or other types of storage media. Note that the memory 320 can have a distributed architecture, where various components are situated remote from one another, but can be accessed by the processor 310.

The software in the memory 320 may include one or more separate programs, each of which comprises an ordered listing of executable instructions for implementing logical functions. The software in the memory 320 includes a suitable operating system (O/S) 350, compiler 340, source code 330, and one or more applications 360 in accordance with exemplary embodiments. As illustrated, the application 360 comprises numerous functional components for implementing the features and operations of the exemplary embodiments. The application 360 of the computer 300 may represent various applications, computational units, logic, functional units, processes, operations, virtual entities, and/or modules in accordance with exemplary embodiments, but the application 360 is not meant to be a limitation.

The operating system 350 controls the execution of other computer programs, and provides scheduling, input-output control, file and data management, memory management, and communication control and related services. It is contemplated by the inventors that the application 360 for implementing exemplary embodiments may be applicable on all commercially available operating systems.

Application 360 may be a source program, executable program (object code), script, or any other entity comprising a set of instructions to be performed. When a source program, then the program is usually translated via a compiler (such as the compiler 340), assembler, interpreter, or the like, which may or may not be included within the memory 320, so as to operate properly in connection with the O/S 350. Furthermore, the application 360 can be written as an object oriented programming language, which has classes of data and methods, or a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices 370 may include input devices such as, for example but not limited to, a mouse, keyboard, scanner, microphone, camera, etc. Furthermore, the I/O devices 370 may also include output devices, for example but not limited to a printer, display, etc. Finally, the I/O devices 370 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 370 also include components for communicating over various networks, such as the Internet or intranet.

If the computer 300 is a PC, workstation, intelligent device or the like, the software in the memory 320 may further include a basic input output system (BIOS) (omitted for simplicity). The BIOS is a set of essential software routines that initialize and test hardware at startup, start the O/S 350, and support the transfer of data among the hardware devices. The BIOS is stored in some type of read-only-memory, such as ROM, PROM, EPROM, EEPROM or the like, so that the BIOS can be executed when the computer 300 is activated.

When the computer 300 is in operation, the processor 310 is configured to execute software stored within the memory 320, to communicate data to and from the memory 320, and to generally control operations of the computer 300 pursuant to the software. The application 360 and the O/S 350 are read, in whole or in part, by the processor 310, perhaps buffered within the processor 310, and then executed.

When the application 360 is implemented in software it should be noted that the application 360 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 360 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium may include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 360 is implemented in hardware, the application 360 can be implemented with any one or a combination of the following technologies, which are well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The technical effects and benefits of exemplary embodiments include automatic management of broadcast messages received by a user on one communication channel in other linked communication channels belonging to the user, such that the user is not required to duplicate actions regarding the message in the linked communication channels.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for broadcast message management, the method comprising:
receiving, at a registration server, a registration comprising a first plurality of communication channels, the first plurality of communication channels comprising a first communication channel and a second communication channel, the first communication channel being associated with a first service provider, the second communication channel being associated with a second service provider; and
providing the registration by the registration server to the first service provider, such that a status notification for a broadcast message, the broadcast message being received by a second plurality of communication channels comprising the first communication channel and the second communication channel, is sent to the second service provider from the first service provider.

2. The method of claim 1, wherein the status notification comprises one or more of read, received, replied, deleted, and forwarded.

3. The method of claim 1, wherein a status of the broadcast message in the second communication channel is changed to reflect the status notification.

4. The method of claim 3, wherein the status notification comprises a unique message identifier associated with the broadcast message, and the status of the broadcast message in the second communication channel is changed based on the unique message identifier.

5. The method of claim 1, wherein the registration comprises authentication information for each of the first plurality of communication channels.

6. The method of claim 4, wherein the status notification comprises the authentication information for the second communication channel.

7. The method of claim 1, wherein the first and second plurality of communication channels comprise at least one of an email account, voicemail, a short message service account, or a chat account.

8. The method of claim 1, wherein the first service provider determines a set of communication channels in both the first and second plurality of communication channels, and sends the status notification to the determined set of communication channels.

9. A system for broadcast message management, the system comprising:
a first communication channel associated with a first service provider;
a second communication channel associated with a second service provider; and
a registration server configured to receive a registration comprising a first plurality of communication channels by a registration server, the first plurality of communication channels comprising the first communication channel and the second communication channel, the registration server further configured to provide the registration to the first service provider, such that a status notification for a broadcast message, the broadcast message being received by a second plurality of communication channels comprising the first communication channel and the second communication channel, is sent to the second service provider from the first service provider.

10. The system of claim 9, wherein the status notification comprises one or more of read, received, replied, deleted, and forwarded.

11. The system of claim 9, wherein the second service provider is configured to change a status of the broadcast message in the second communication channel to reflect the status notification.

12. The system of claim 11, wherein the status notification comprises a unique message identifier associated with the broadcast message, and the second service provider is configured to change the status of the broadcast message in the second communication channel based on the unique message identifier.

13. The system of claim 9, wherein the registration comprises authentication information for each of the first plurality of communication channels.

14. The system of claim 13, wherein the status notification comprises the authentication information for the second communication channel.

15. The system of claim 9, wherein the first and second plurality of communication channels comprise at least one of an email account, voicemail, a short message service account, or a chat account.

16. The system of claim 9, wherein the first service provider is configured to determine a set of communication channels in both the first and second plurality of communication channels, and send the status notification to the determined set of communication channels.

17. A computer program product comprising a computer readable storage medium containing computer code that, when executed by a computer, implements a method for broadcast message management, wherein the method comprises:
receiving, at a registration server, a registration comprising a first plurality of communication channels, the first plurality of communication channels comprising a first communication channel and a second communication channel, the first communication channel being associated with a first service provider, the second communication channel being associated with a second service provider; and
providing the registration by the registration server to the first service provider, such that a status notification for a broadcast message, the broadcast message being received by a second plurality of communication channels comprising the first communication channel and the second communication channel, is sent to the second service provider from the first service provider.

18. The computer program product according to claim 17, wherein the status notification comprises one or more of read, received, replied, deleted, and forwarded.

19. The computer program product according to claim 17, wherein a status of the broadcast message in the second communication channel is changed to reflect the status notification.

20. The computer program product according to claim 17, wherein the first service provider determines a set of communication channels in both the first and second plurality of communication channels, and sends the status notification to the determined set of communication channels.
